(19) United States
(12) Patent Application Publication
(10) Pub. No.: US 2026/0008232 A1
(43) Pub. Date: Jan. 8, 2026

(54) ADDITIVE MANUFACTURING SYSTEM

(71) Applicant: Turbo 3d LLC, Gardena, CA (US)

(72) Inventor: Alexandr Shkolnik, Los Angeles, CA (US)

(21) Appl. No.: 18/980,993

(22) Filed: Dec. 13, 2024

Related U.S. Application Data
(63) Continuation-in-part of application No. 18/762,593, filed on Jul. 2, 2024, now Pat. No. 12,202,210.

(51) Int. Cl. B29C 64/241; B29C 64/129; B29C 64/245; B29C 64/264; B29C 64/393; B33Y 10/00; B33Y 30/00; B33Y 50/02

(52) U.S. Cl. CPC B29C 64/241; B29C 64/129; B29C 64/245; B29C 64/264; B29C 64/393; B33Y 10/00; B33Y 30/00; B33Y 50/02

(57) ABSTRACT

An additive manufacturing system is described that provides centrifuge-based additive object manufacturing includes a drum containing a working material that solidifies after being irradiated by a light source, the working material spreads evenly over an item being manufactured when the drum is in motion. A light source module emitting a light capable of solidifying the working material includes multiple light sources that travel upward and downward within the drum in vertically offset helical patterns to efficiently solidify the working material.

### RELATED APPLICATIONS

This application is a continuation in part of U.S. patent application Ser. No. 18/762,593, “Additive Manufacturing System,” filed Jul. 2, 2024, which is incorporated by reference in its entirety and for all purposes.

### BACKGROUND

### Field of Use

The present disclosure relates to a system and method for providing 3D object manufacturing, and more specifically, to a system and method for providing centrifuge-based additive object manufacturing.

### DESCRIPTION OF RELATED ART

Current techniques for additive manufacturing of three-dimensional objects (e.g., stereolithography, 3-D printing, etc.) can produce excellent quality products with high fidelity, but such techniques have significant limitations. Typically, such techniques work in one of three ways: (a) continually polymerizing layers at or near the surface of liquid resin contained in a stationary vat, (b) continually polymerizing layers of resin at or near the bottom of a stationary vat of resin through a transparent membrane, or (c) continually polymerizing layers of resin that have been jetted downward by one or more single-nozzle or multi-nozzle print heads.

Technique (a) requires maintaining tight control over the material level and leading to part inaccuracies due to a meniscus forming, voids during material application, etc. Technique (b) often causes process failures and thus destruction of the objects forming due to separation forces. Even utilizing the so-called “dead zone” is prone to failures due to vacuum forces created during the process of delivering material for the next layer. Technique (c) requires a uniform distribution of a newly formed layer over the previous one, which is not an easy task.

Therefore, a need exists for systems and methods for providing improved additive object manufacturing. The present disclosure attempts to address the limitations and deficiencies of prior solutions utilizing the principles and example embodiments as disclosed herein.

### SUMMARY

In accordance with the present disclosure, the above and other problems are solved by providing a system and method for providing centrifuge-based additive object manufacturing according to the principles and example embodiments disclosed herein.

An additive manufacturing system is described and includes a drum having an interior-facing curved surface; a light source module comprising a plurality of light sources; a processor configured to execute computer code that when executed causes the additive manufacturing system to: rotate the drum; apply a first layer of working material to the interior-facing curved surface; move the light source module disposed at least partially within the drum toward a base of the drum such that the plurality of light sources follow a first plurality of scanlines across the first layer of the working material in a first helical pattern; apply a second layer of working material to the interior-facing curved surface atop the first layer of working material; and move the light source module away from the base of the drum such that the plurality of light sources of the light source module follow a second plurality of parallel scanlines across the second layer of material in a second helical pattern. The light source module moves at a speed such that actuation of a light source of the plurality of light sources over a first region of the working material during two consecutive rotations of the drum results in unsolidified material being left between a first portion of the first region solidified by the light source during a first one of the consecutive rotations and second portion of the first region solidified by the light source during a second one of the consecutive rotations.

In some embodiments, the first plurality of scanlines are vertically offset from the second plurality of scanlines.

In some embodiments, the plurality of light sources are each separated by a scanline interval and the first plurality of scanlines is offset vertically from the second plurality of scanlines by half of a scanline interval.

In some embodiments, the plurality of light sources are turned on and off during rotation of the drum and vertical movement of the light source module to solidify portions of the first and second layers of working material to form one or more parts on the interior-facing curved surface of the drum.

In some embodiments, the additive manufacturing system also includes a motor configured to move the light source module toward and away from the base of the drum.

In some embodiments, the additive manufacturing system also includes a sensor configured to measure a rotational position of the drum, wherein the additive manufacturing system direct changes to operation of the light source module based on a determined rotational position and/or speed of the drum.

In some embodiments, the sensor is a laser indexer and wherein the processor is configured to interpolate a rotational position of the drum based on a tic mark of the laser indexer most recently detected by the laser indexer and an estimated rotational speed of the drum.

In some embodiments, the plurality of light sources are laser diodes arranged vertically within the light source module.

In some embodiments, the additive manufacturing system reduces a power output of a first light source of the plurality of light sources when the first light source is tracking across a final rotation of the drum before the light source assembly changes direction within the drum, such that portions of the working material where a first scanline of the first light source overlaps a second scanline of the second light source do not receive too much light energy.

In some embodiments, the light source module pauses operation while the second layer of working material is applied to the interior-facing curved surface of the drum.

A method is described and includes rotating a drum of an additive manufacturing system; applying a first layer of working material to an interior-facing curved surface of the drum; moving a light source module disposed at least partially within the drum toward a base of the drum such that a plurality of light sources of the light source module trace a first plurality of scanlines across the working material on the interior-facing curved surface of the drum in a first helical pattern; and applying a second layer of working material to the interior-facing curved surface of the drum; moving the light source module away from the base of the drum such that the plurality of light sources of the light source module trace a second plurality of parallel scanlines across the second layer of working material on the interior-facing curved surface of the drum in a second helical pattern, The light source module moves at a speed such that actuation of a light source of the plurality of light sources over a first region of the working material during two consecutive rotations of the drum results in unsolidified material being left between a first portion of the first region solidified by the light source during a first one of the consecutive rotations and second portion of the first region solidified by the light source during a second one of the consecutive rotations.

In some embodiments, the first plurality of scanlines are vertically offset from the second plurality of scanlines.

In some embodiments, scanlines of the first plurality of scanlines are vertically offset from each other by a scanline interval and the second plurality of scanlines are vertically offset from the first plurality of scanlines by half of a scanline interval.

In some embodiments, the method also includes turning on and off the plurality of light sources during rotation of the drum and vertical movement of the light source module to solidify portions of the first and second layers of working material to form one or more parts on the interior-facing curved surface of the drum.

In some embodiments, the additive manufacturing system comprises a motor configured to move the light source module toward and away from the base of the drum.

In some embodiments, the additive manufacturing system includes a sensor configured to measure a rotational position of the drum and the method further comprises: directing changes to operation of the light source module based on a determined rotational position and/or speed of the drum.

In some embodiments, the sensor is a laser indexer and the method further comprises interpolating a rotational position of the drum based on a tic mark of the laser indexer most recently detected by the laser indexer and an estimated rotational speed of the drum.

In some embodiments, the plurality of light sources are laser diodes arranged vertically within the light source module.

In some embodiments, the method also includes reducing a power output of a first light source of the plurality of light sources when the first light source is traversing a final rotation of the drum before the light source assembly changes direction within the drum, such that portions of the working material where a first scanline of the first light source overlaps a second scanline of the second light source do not receive more than a threshold amount of light energy.

In some embodiments, the method also includes pausing operation of the light source module while the second layer of working material is applied to the interior-facing curved surface of the drum.

### BRIEF DESCRIPTION OF THE DRAWINGS

The features, objects, and advantages of the present disclosure will become more apparent from the detailed description set forth below when taken in conjunction with the drawings, wherein:

FIGS. 1A, 1B, and 1C show side, front and perspective views, respectively, of an exemplary centrifugal additive manufacturing system;

FIG. 2 shows a perspective view of a select group of components of an additive manufacturing system that illustrates a cross-section of portions of a drum, a motor, a rotary union and a material delivery channel;

FIGS. 3A, 3B, and 3C show cross-sectional side views of, respectively, a drum, a motor and a light source module inserted within the drum during operation of the system;

FIGS. 3D and 3E show exploded and cross-sectional views, respectively, of a specific implementation of a rotary union;

FIG. 4A shows a top down cross-sectional view of multiple parts being prepared in a drum of a centrifugal additive manufacturing system in accordance with the described embodiments;

FIG. 4B shows an alternative embodiment in which fins 410 are attached to an interior-facing surface of a lid of a drum;

FIG. 5 shows an alternative embodiment in which a drum is rotated at high speeds while metal powder mixed with a gas such as nitrogen is blown into a drum at a 30 to 60 degree angle depending on the dimensions of drum using a gas blower;

FIG. 6 shows an exemplary plot 600 showing the importance of various parameters to the success of operation of the present additive manufacturing embodiments;

FIG. 7 shows an exemplary electronic device usable with the described embodiments; and

FIG. 8 shows a timeline illustrating operation of an exemplary additive manufacturing device compatible with the embodiments depicted in FIGS. 1A-4B; and

FIGS. 9A, 9B, 9C, 9D, 9E, 9F, and 9G illustrate a method of operation of a light source assembly while creating parts within additive manufacturing system depicted in FIGS. 1A-4B.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

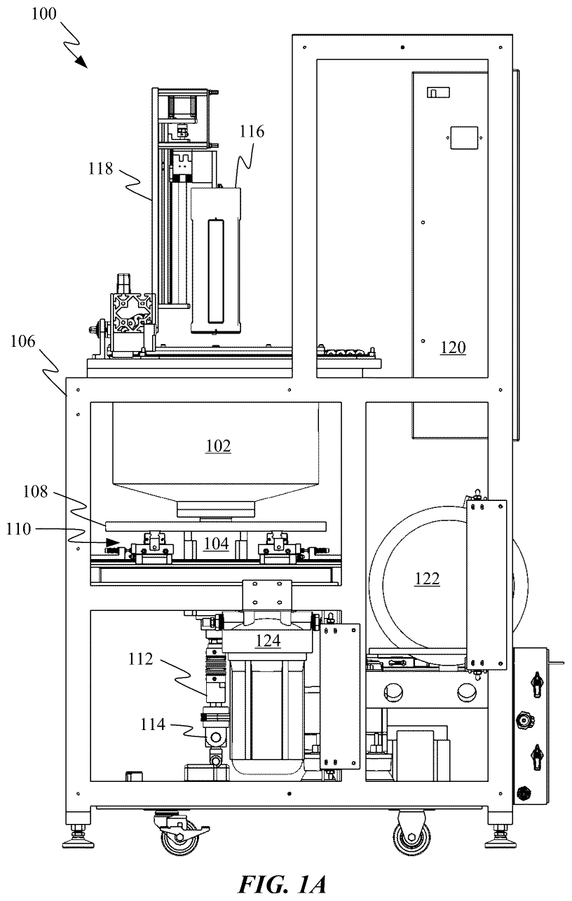

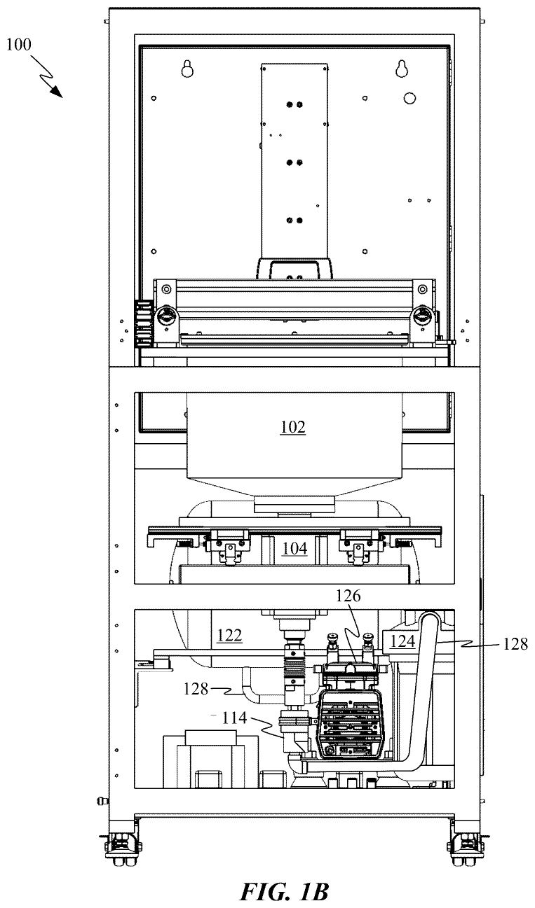

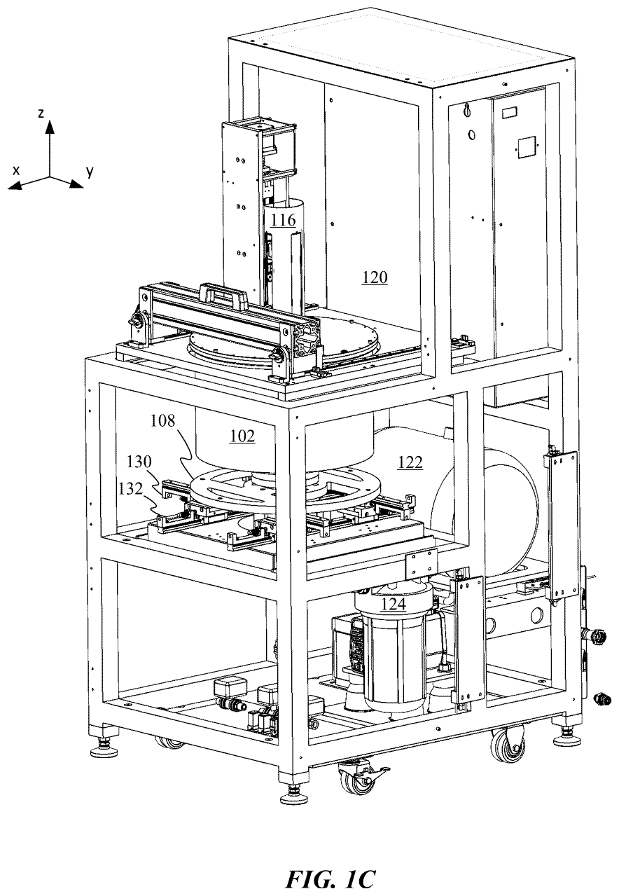

In general, the present disclosure relates to a system and method for providing 3D object manufacturing. The disclosed embodiments each involve the application of a new layer of material, such as a photopolymer, a powder or any other type of material that is capable of changing phase or solidifying under irradiation. To better understand the present disclosure, FIGS. 1A-1C show side, front and perspective views of a centrifugal additive manufacturing system 100 attached to a mobile cart that allows for system 100 to be transported to various locations. It should be appreciated that centrifugal manufacturing system 100 can instead be attached to a fixed location. A fixed location can be more beneficial in situations where increased stability is desired and/or the system is scaled up in size to a point where easy relocation is no longer feasible.

FIG. 1A shows a first side view of system 100. System 100 includes a drum 102 within which system 100 creates new parts. Motor 104 is located beneath drum 102 and configured to rotate drum 102. Motor 104 can be a direct drive motor attached directly to a base of drum 102. In some embodiments, drum 102 and motor 104 can be attached to cart 106 by a motor mounting plate 108 and a suspension system 110 that allows for a limited amount of lateral movement of drum 102 and motor 104 during operation of system 100. Allowance of a small amount of lateral movement can be helpful in preventing unwanted vibrational excursions when rotating drum 102 at high rotational velocities. Suspension system 110 includes a series of springs and rails that biases a position of drum 102 and motor 104 toward a central location but as mentioned above also allows for up to 5 mm of lateral movement to help dissipate undesired vibrational excursions of drum 102 resulting from addition, subtraction or movement of materials within drum 102.

A material deliver channel 112 extends through and along a longitudinal axis of motor 104 and into a base of drum 102. A series of bushings further extend a length of material delivery channel 112 below motor 104 and to a rotary union 114, which includes one or more ports for supplying material into material delivery channel 112. Rotary union 114 includes a stationary lower assembly for attachment to one or more hoses for supplying material into material delivery channel 112 and an upper assembly coupled to the lower assembly by a bearing that allows for rotation of the upper assembly relative to the lower assembly. This configuration allows material delivery channel 112 to rotate with drum 102 so that material being supplied to drum 102 through material delivery channel 112 shares the same inertial reference frame as drum 102 prior to arriving and being deposited within drum 102. This helps to improve an evenness of the distribution of material being added into the base of drum 102.

FIG. 1A also shows a location of a light source module 116 elevated above drum 102. As depicted, light source module 116 is affixed to cart 106 by a vertical movement assembly 118 that includes a motor responsible for moving light source module 116 vertically into and out of a light source module opening in drum 102 during operation of system 100. An electrical panel 120 is attached to a rear side of cart 106 and configured to power the various components of system 100. FIG. 1A also shows a location of tank 122, which is responsible for holding material that is introduced into drum 102 and in some embodiments also responsible for regulating a temperature of the material so that when used its properties are as expected. In some embodiments, the material held by tank 122 can be a photopolymer material that solidifies when irradiated by a light source. Also depicted is a filter 124 that can optionally be utilized to remove any impurities in the material held within tank 122 prior to the material being introduced into drum 102.

FIG. 1B shows a front view of system 100 that illustrates a location of pumping mechanism 126 relative to other components of system 100. In particular, pumping mechanism 126 is linked by one or more conduits 128 to other components and designed to utilize those conduits to move material from tank 122, through filter 124 and into rotary union 114 and ultimately up material delivery channel 112, through motor 104 and into drum 102. Pumping mechanism 126 can be designed to periodically deliver precise amounts of material into drum 102 to avoid instances of a waste of material or an overly thick or thin layer of material that negatively affects accuracy or stability of a resulting part. Exemplary layer thicknesses generally vary from between 10 microns to 50 microns but can also vary more widely between a range of 5 microns and 250 microns depending on the intended purpose of the work to be done by the system. In some embodiments, pumping mechanism 126 can take the form of a motorized syringe style delivery mechanism allowing a precise cylindrical displacement of working material to be added to provide material into drum 102 in a precise amount and at a precise rate. In other embodiments, other types of pumping mechanisms can be used such as metering pumps, plunger pumps or diaphragm pumps. In some embodiments, system 100 can include multiple pumping mechanisms to inject different types of fluids into and out of drum 102. For example, cleaning and/or curing fluids can also be routed through material delivery channel 112.

FIG. 1C shows a perspective view of system 100 and a view of suspension system 110, which includes orthogonal bearings 130 and 132 that accommodate small movements in the X and Y directions. Motor mounting plate 108 is also shown fastened in multiple locations to suspension system 110 in a manner such that motor mounting plate is prevented from rotating during operation of system 100, thereby allowing motor 104 to drive operation apply rotation to drum 102.

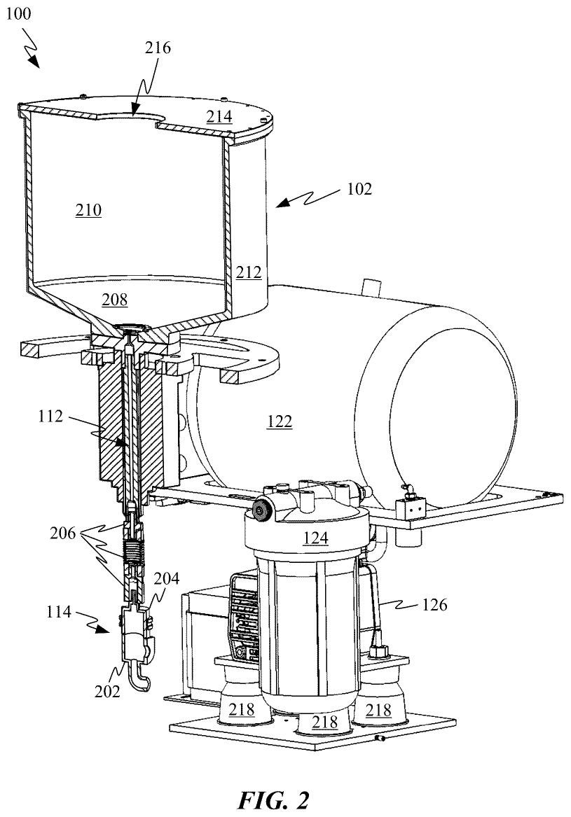

FIG. 2 shows a perspective view of a select group of components of system 100 that illustrates a cross-section of portions of drum 102, motor 104, rotary union 114 and material delivery channel 112. In particular, rotary union 114 is shown with lower assembly 202 and upper assembly 204 that is configured to rotate with respect to lower assembly 202. Lower assembly 202 is shown with two ports for attaching conduits configured to deliver material stored in tank 122 or cleaning or curing solution stored in other containers of system 100 into material delivery channel 112. Once the liquid passes through rotary union 114 it enters the portion of material delivery channel formed by bushing elements 206 that connect rotary union 114 to motor 112.

FIG. 2 also shows how drum 102 includes a sloped interior-facing bottom surface leading up to a curved sidewall 210. An angle of the interior facing bottom surface could be sloped at an angle of between 10 and 25 degrees. In one particular embodiment, a sloped angle of 18 degrees can be used. The sloped bottom surface reduces the speed material hits sidewall 210 and thereby prevents the material from splashing and thereby spreading more turbulently when hitting sidewall 210 at higher speeds. In some embodiments, a conformal sleeve can be arranged along curved sidewall 210 allowing for parts formed against sidewall 210 to be easily removed from drum 102 following part formation. Furthermore, the conformal sleeve can be formed of flexible material such as sheet metal that when flattened pulls away from the curved rearward geometry of formed parts to easily separate the parts without doing unintentional damage.

FIG. 2 also shows how drum 102 can be formed of a main body 212 and a lid 214. Lid 214 includes an opening 216 sized to receive light source module 116. Opening 216 can be sized slightly larger than a diameter of light source module 116 such that drum 102 is able to shift laterally, as allowed by suspension 110, without resulting in any collisions between light source module 116 and drum 102. FIG. 2 also shows pump mechanism 126 mounted on multiple springs 218 that help prevent any vibrations generated by operation of pump mechanism 126 from disrupting consistent rotation of drum 102 during operation of system 100.

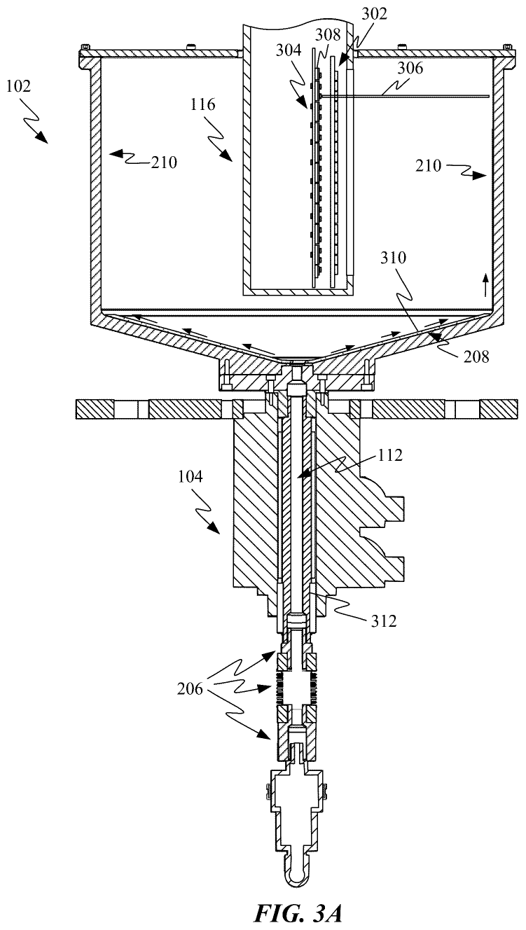

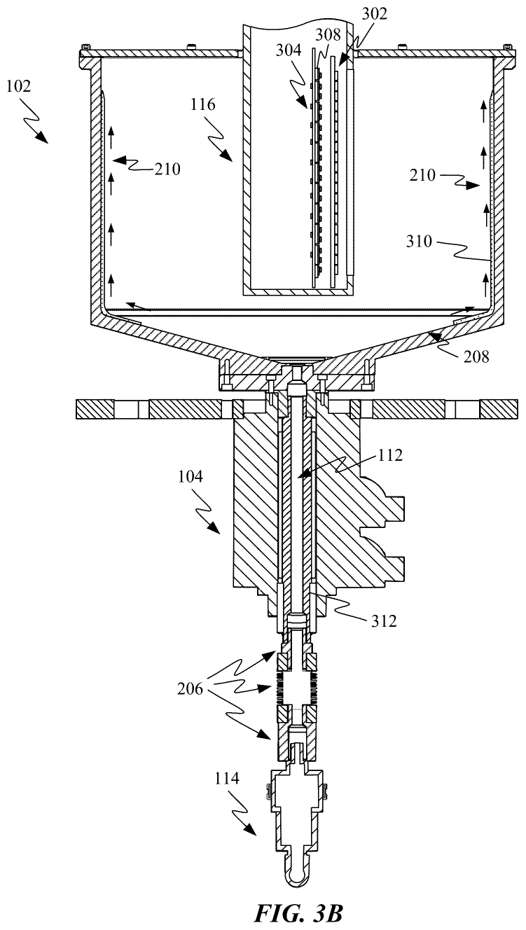

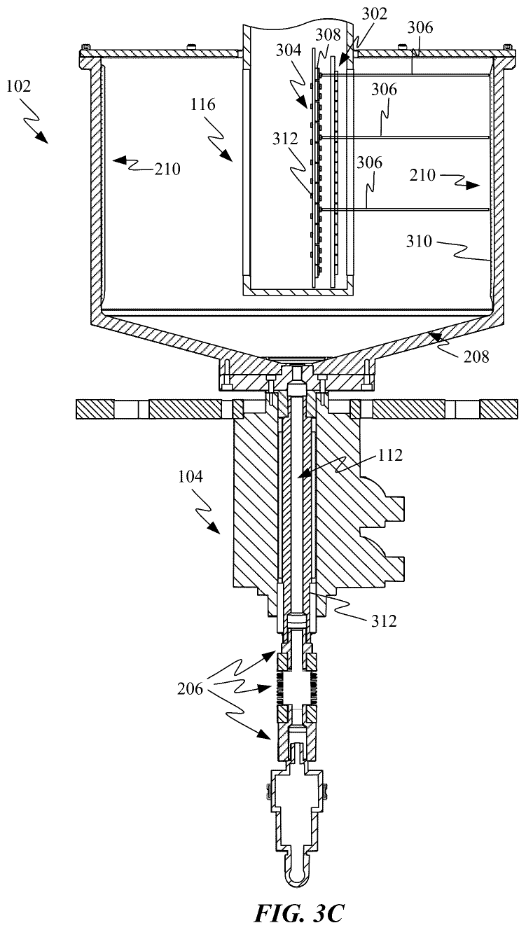

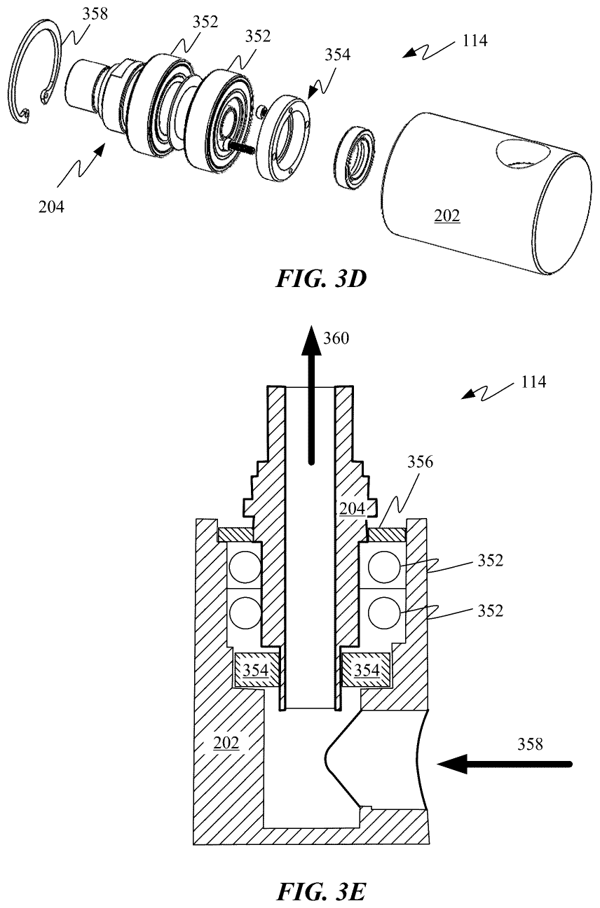

FIG. 3A shows a cross-sectional side view of drum 102, motor 104 and light source module 116 inserted within drum 102. Light source module 116 is inserted within drum 102 during normal operation of system 100. Light source module includes a lens assembly 302 and a light source assembly 304. Lens assembly 302 is configured to move closer to or farther away from light source assembly 304 in order to focus light 306 generated by laser diodes 308 arranged along light source assembly 304 on curved sidewall 210. While only a single laser diode is shown emitting light 308 it should be appreciated that all 20 laser diodes depicted in FIG. 3 could be concurrently activated in the event a particularly large part is being built within drum 102. Since light source module 116 does not rotate with drum 102, laser light emitted by light source module 116 scans across curved surface at the speed of the rotation of drum 102. While a light source module 116 is shown that includes 20 laser diodes 306, it should be appreciate that a fewer or larger number of laser diodes and associated lenses is also possible. In some embodiments, light source module 116 can translate vertically in order to allow the light generated by the laser diodes to solidify portions of material arranged on sidewall 210 that is located vertically between laser diodes 308. In some embodiments, laser diodes and lenses can be packed together at an interval allowing coverage of an entirety of material arranged on sidewall 210 during operation of system 100. In the present embodiment, each laser diode can be responsible for covering a vertical length of about 10-15 mm.

In addition to carrying laser diodes, light source module can also include LEDs designed to apply a curing process to the finished parts within drum 102. In some specific embodiment, the LEDs can be incorporated into a first side of light source assembly 304 opposite from a second side of light source assembly 304 that carries laser diodes. By placing optical windows on opposing sides of light source module 116, light source module 116 can assist with both solidification of the working material and with curing of the solidified working material.

Timing of the actuation of light source module 116 is important to the proper formation of parts within drum 102. Furthermore at the speeds that drum 102 travels, conventional methods of determining with high precision a rotational position of drum 102 is quite challenging. The presently disclosed system 100 incorporates a sensor known as a laser encoder to determine a current rotational position of drum 102. However due to the rapid rotational speeds commonly reached by drum 102 (e.g. greater than 1500 rpm or between 1200 and 3000 rpm), utilizing a standard, off the shelf laser encoder would lack the accuracy needed to fire the various laser diodes that drive light source module at precisely the right times to get a desired level of part accuracy. This is a result of a standard laser encoder not being capable of including a large enough number of tic marks it relies upon to tell current rotational position. For this reason, a processor being utilized to fire the light generating components of light source module 116 at the proper times can interpolate a current rotational position of drum 102 by estimating a rotational position of drum 102 utilizing instantaneous drum rotational speeds. In this way, instead of reporting the final tic mark detected by the laser encoder a position of drum 102 between tic marks can be determined and used to help determine a more precise time at which light source module 116 is set to operate each of its light generating components or laser diodes in the present exemplary embodiment.

FIG. 3A also shows a flow of material 310 delivered through material delivery channel 112 up sloped bottom surface 208 of drum 102 as it approaches sidewall 210. In some embodiments, solidification operations are paused as the material for forming the next layer in drum 102 begins flowing up side wall 210. In some embodiments, it can take between 0.5 and 2 seconds for the material to travel from pump mechanism 126 to a base portion of sidewall 210 and then about 0.2 to 0.5 seconds to make its way up the sidewall of drum 102. Time taken will depend on the height of the walls of drum 102, the amount of material supplied and the speed at which the material is pumped into drum 102. Thickness of the layers of material arranged on curved side wall 210 can be driven by a speed of rotation of drum 102. Generally, by varying the rotational speed and resulting amount of centrifugal forces applied to the liquid material on sidewall 210, the designers have the benefit of specifying specific layer thicknesses when needed to achieve a specific part accuracy. This is achievable with the disclosed configurations since higher g-forces tend to compress the liquid material against sidewall 210 by a greater amount than lower g-forces.

FIG. 3A also shows how a portion of material delivery channel 112 running through motor 104 is defined by tubing 312, which keeps any of the material from getting lodged within mechanical components of motor 104 as it moves from bushing elements 206 to drum 102. While tubing is used in this particular configuration it should be appreciated that a motor could also be used with a liquid resistance channel instead of the tubing shown in FIG. 3A. As depicted, tubing 312 connects one end of bushing elements 206 to a base portion of drum 102. FIG. 3B shows how material 310 moves up bottom wall 208. During this time and as depicted illumination from laser diodes 308 is ceased. This offers a large benefit over previously designed systems that generally require use of a material deposition arm or module taking up space within the working space, resulting in high complexities and limitations that can slow operation of the system.

FIG. 3C shows a final resting position for material 310 prior to it stabilizing in place to form a flat layer on curved sidewall 210 due to the influence of centrifugal force caused by rotation of drum 102. FIG. 3C also shows how multiple laser diodes 308 can be active at once. Furthermore, as additional layers of material get built up on sidewall 210 a position of lens assembly 302 shifts position to keep a focus of laser diodes 308 on the latest layer of material added. In some embodiments, light source module 116 can be calibrated without fixing any minor positioning anomalies with the multiple laser diodes and associated optics. Instead a location of the light can be observed and then operation of the system can be adjusted so that lasers that are out of alignment adjust their timing so that the right material is solidified at the right time. In some embodiments, light source assembly can be tested at the beginning of each operation so that proper calibration can be confirmed and/or updated to get optimal results. The calibration causes the plans for creating the part to be adjusted for any lasers that are determined to be out of alignment so that the lasers activate at the proper time.

FIG. 3D-3E show exploded and cross-sectional views of a specific implementation of rotary union 114. In particular, lower assembly 202 can be referred to as a rotary union body and upper assembly 204 can be referred to as a rotary union spindle. Upper assembly 204 is able to spin relative to lower assembly 202 without generating much friction on account of ball bearings 352. This is much more efficient than most current solutions that rely on two rubbing rings/surfaces, which would generate a much larger amount of heat than desired. In some embodiments, the surfaces in contact with the ball bearings can be polished to further reduce the amount of heat/wear generated during part operation. A seal 354 is positioned near a base of upper assembly 204 and prevents the ingress of liquids into the portion of rotary union 114 in which ball bearings 352 resides. A retaining ring 356 can be used to keep ball bearings 352 seated between upper assembly 204 and lower assembly 202. When rotary union is being used to add material into material delivery channel 112, the material enters rotary union 114 at the location indicated by arrow 358 and exits rotary union 114 at the location indicated by arrow 360.

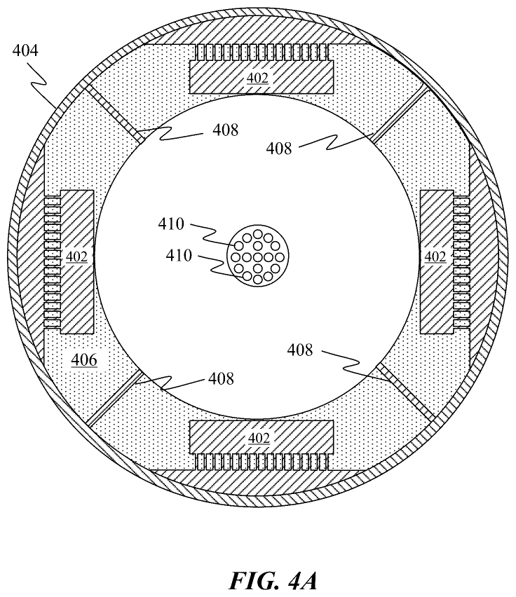

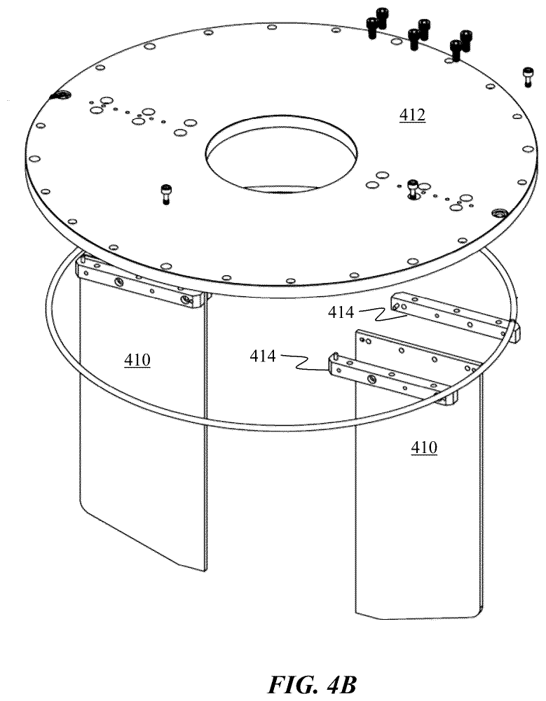

FIG. 4A shows a top down cross-sectional view of multiple parts 402 being prepared in a drum 404 of a centrifugal additive manufacturing system in accordance with the described embodiments. Parts 402 are formed by solidifying the material added into drum 404 over the course of part formation. FIG. 4A shows how drum 404 looks before spinning down so that unsolidified material 406 remains affixed to sidewalls of drum 404. In addition to parts 402, flow stoppers 408 can be formed between parts. Flow stoppers 408 are configured to prevent waves of unsolidified material from being formed during rotation of drum 404 and causing undesirable rotational motion likely to negatively affect production of parts and/or diminish the lifespan of the machine. In some embodiments, instead of using the additive manufacturing system for forming the flow stoppers 408, pre-made flow stoppers or fins can be attached to drum 404 by either slotting into a main body of drum 404 or by attaching to a lid of drum 404 and then being lowered into an interior volume defined by drum 404. It should be noted that by scaling up the size of drum 404 can result in a less severe curvature and fewer issues creating parts with flat surfaces. In some embodiments an orientation of the part within drum 404 can be established to minimize issues in which many surfaces require multiple layers to form.

FIG. 4A also demonstrates how the curvature of the powder layers can differ from the geometry of parts 402 that have linear surfaces. One result is that unlike slower conventional flat additive manufacturing system a flat surface facing the longitudinal axis of drum 404 is constructed using more than one layer due to the mismatch between the layer geometry and the part geometry. In these instances there can be some amount of surface discontinuity as a result when layers have a larger thickness. One advantage to the fixed laser configuration described herein is that power output of the laser can be modulated to produce a smoother surfaces in situation where a single surface needs to be produced over the course of multiple layers. For example, a processor can be configured to modulate the output power of each laser diode of the light source module between at least three different power states (e.g., off, full power and partial power). In some embodiments, previously mentioned fine tuning of determination of rotational positioning allows partial power passes to be applied with high accuracy to smooth areas that might otherwise show obvious scan lines between layers. Conventional additive manufacturing systems utilize a fixed power laser and so must just accept any rough part surfaces resulting from these mismatches in part and material layer geometry.

FIG. 4B shows an alternative embodiment in which fins 410 are attached to an interior-facing surface of lid 412. Fins 410 can be attached via one or more fasteners that extend through openings in lid 412 and into adapters 414 configured to secure fins 410 to lid 412. In this way fins 410 act as flow stoppers or flow inhibitors removing the need to have the additive manufacturing system create flow stoppers.

Once parts are formed the system can be further configured to evacuate unsolidified material 406 through openings 410 that allow the unsolidified material 406 to exit through material delivery channel 112 (see FIGS. 2-3C). Following evacuation of unsolidified material 406, alcohol can be pumped into and back out of drum 404 again using the material delivery channel 112 in order to clean parts 402 of any excess unsolidified material 406. Following the cleaning step material delivery channel 112 can again be utilized to introduce curing agent into drum 404. In addition to carrying a set of laser diodes for solidifying the working material within the drum, the light source module can also include a set of LEDs having an output suited for curing finished parts following the washing process. Manufacturers can save substantial time and expense since the described embodiments do not require the finished parts to be taken to a variety of different locations to undergo the washing and curing steps.

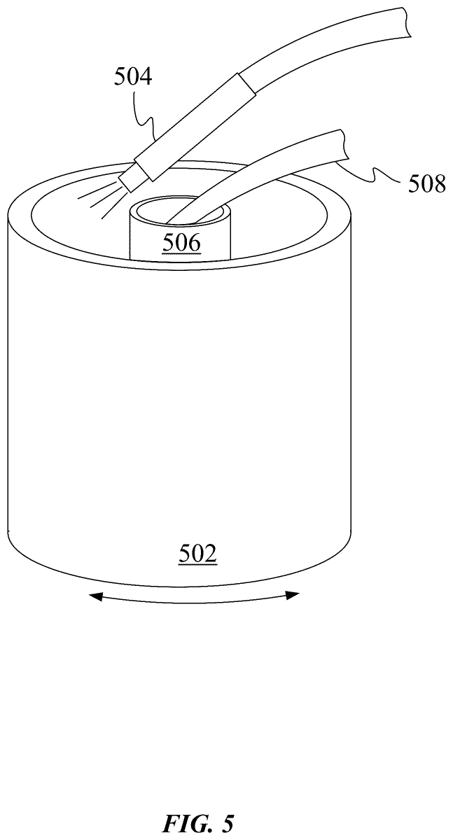

FIG. 5 shows an alternative embodiment in which a drum 502 is rotated at high speeds while metal powder mixed with a gas such as nitrogen is blown into drum 502 at a 30 to 60 degree angle depending on the dimensions of drum 502 using a gas blower 504. By angling the gas-borne metal powder into drum 502 the metal powder imbued gas forms a vortex within drum 502 and then centrifugal force exerted on the metal powder keeps the metal powder affixed to interior facing curved walls of drum 502 while a light source assembly 504 is lowered into drum 502 in a similar way as to how it is placed in the previously described drum and light source assemblies. Metal powder generally takes a more powerful type of laser such as, e.g., a YAG laser. In this embodiment, a YAG laser can be positioned outside drum 502 and its light channeled into light source assembly 504 using multiple fiber optic cables such that the output of the single powerful YAG laser can be divided to have a similar but more powerful configuration that the light source module described with regards to system 100. Each fiber optic cable can be incorporated into cable bundle 508 and attached to an optical pathway that can include focusing elements within light source assembly 504. An acousto-optical modulator can be arranged along each of the fiber optic cables and configured to turn off and on the laser output being split into each of the fiber-optic cables, to correspond to requirements for building parts within drum 502.

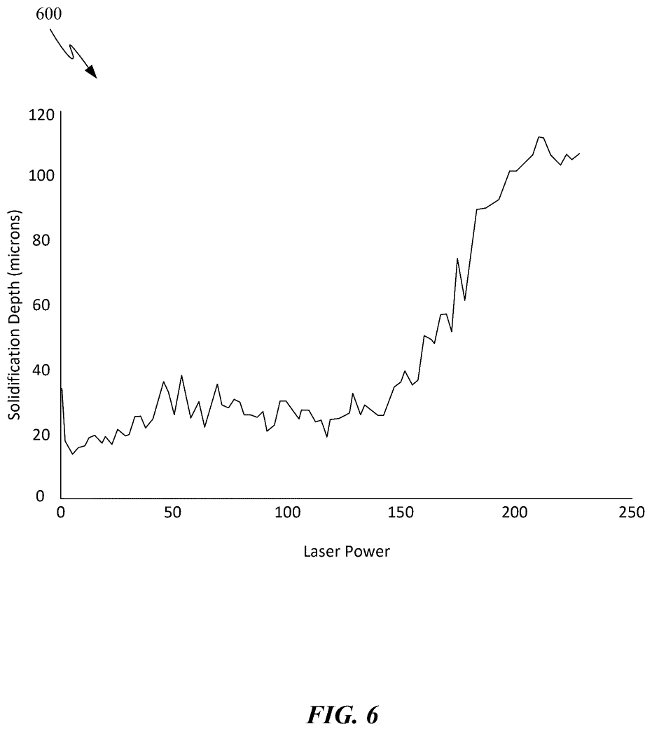

FIG. 6 shows an exemplary plot 600 showing the importance of various parameters to the success of operation of the present additive manufacturing embodiments. In particular, it shows how laser power must be modulated in order to get a desired depth of part material solidification. Solidifying too deep or too shallowly can result in part inaccuracies. This graph also demonstrates how a partial power laser could be configured to perform the type of layer blending operation described above as it allows for a different depth of solidification to be achieved thereby creating a blending layer in places.

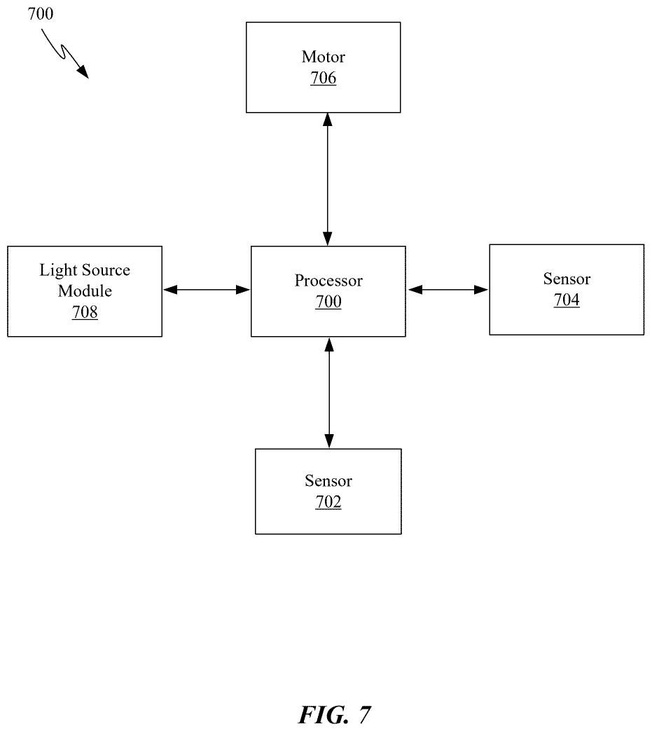

FIG. 7 shows an exemplary electronic device 700 usable with the described embodiments. In particular, processor 700 represents one or more processors responsible for operation of a system such as system 100. Processor 700 can be responsible for collecting information from multiple sensors, such as sensors 702 and 704. In some embodiments, sensor 702 can take the form of a laser indexer utilized to measure a rotational position of a drum of a system. As discussed previously, processor 700 can be configured to use the position information provided by the laser indexer, calculate a speed and/or acceleration of the drum at any point in time to accurately estimate with high accuracy a position of the drum at any point in time. Processor 700 can then take the position, speed and/or acceleration information and use it to adjust operation of motor 706 utilized to spin the drum and/or modulate output of light source module 708. In some embodiments, processor 700 may want to avoid requiring too strict an operating speed as additions of materials into the drum can result in changes in to the drum inertia and rotational energy that can make maintaining a strict band of rotational velocity overly difficult. As long as the rotational position sensor accurately tracks speed, processor 700 can command changes to operation of light source module 704 in order to achieve highly accurate part accuracies.

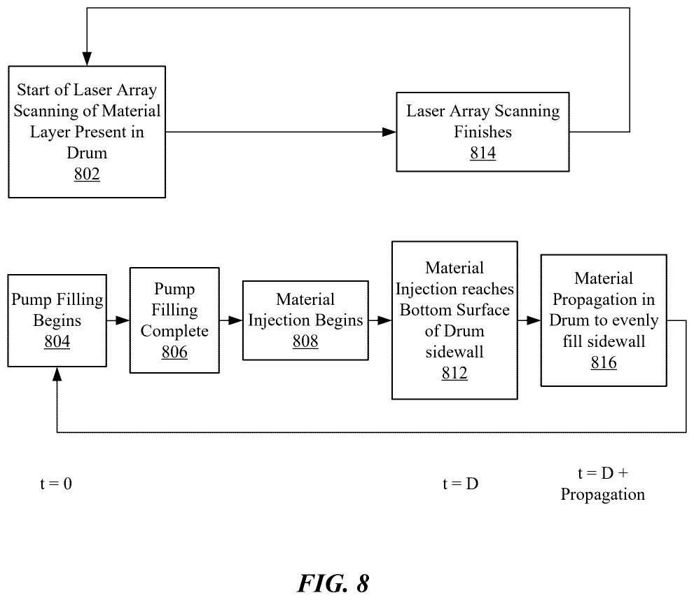

FIG. 8 shows a timeline illustrating operation of an exemplary additive manufacturing device compatible with the embodiments depicted in FIGS. 1A-4B. At 802 and at time t=0, an array of lasers of a light source module begins scanning a material layer arranged upon a sidewall of a drum in accordance with the previously described embodiments. At 804 and also at time t=0, a fixed amount of temperature controlled working material is prepared for injecting into a material delivery channel of the additive manufacturing system. In embodiments where the pump mechanism takes the form of a syringe style delivery system, the syringe begins to be filled at time t=0 with the fixed amount of working material in preparation for injecting. Other pump mechanisms can include a small holding tank where the fixed amount of working material is stored while waiting for injection into the system. At 806, the pump mechanism filling completes while the laser array continues scanning the working material previously added to the drum.

At 808, the pump mechanism begins moving the fixed amount of working material into the material delivery channel where it begins making its way toward the drum. At 808 and time t=D, the working material after entering the drum reaches a base of an interior-facing curved surface of the drum. At 814 and also at time t=D the light source module ends the scanning operation and the working material starts to climb up the curved interior sidewall. At 816 and time t=D+propagation, the new layer of working material evenly coats the interior-facing surface of the drum and the process returns to 802 and 804 where laser scanning and pump filling begin again.

It should be appreciated that while some specific examples of working materials have been given, such as photopolymers that other types of materials are also possible. For example, in some embodiments, the working material can take the form of a slurry incorporating metal powder that allows for the formation of a metal part using the embodiments shown in FIGS. 1A-4B.

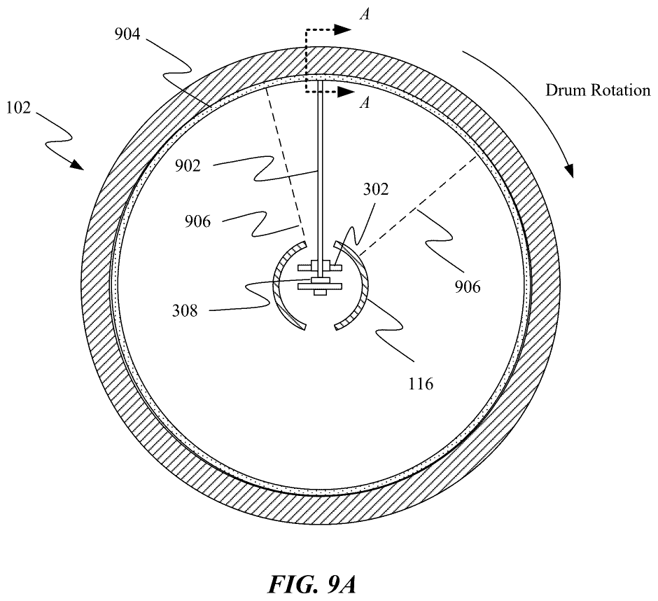

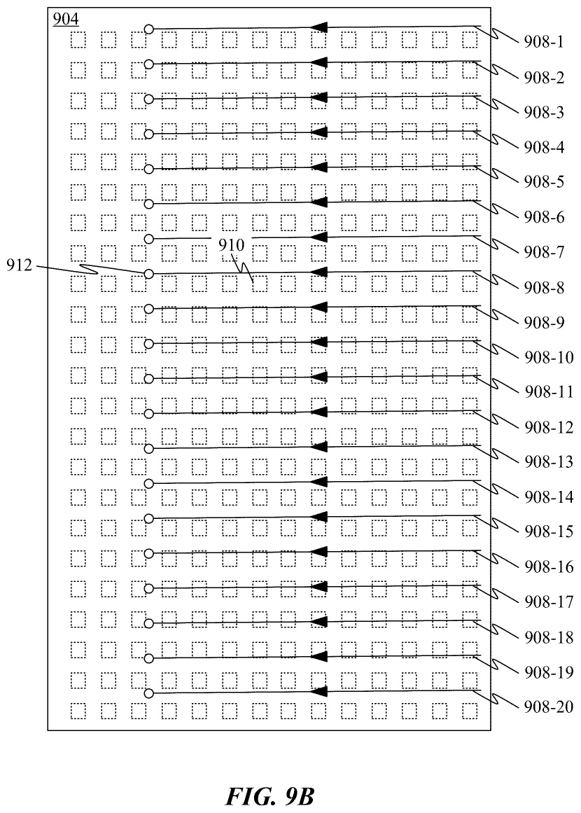

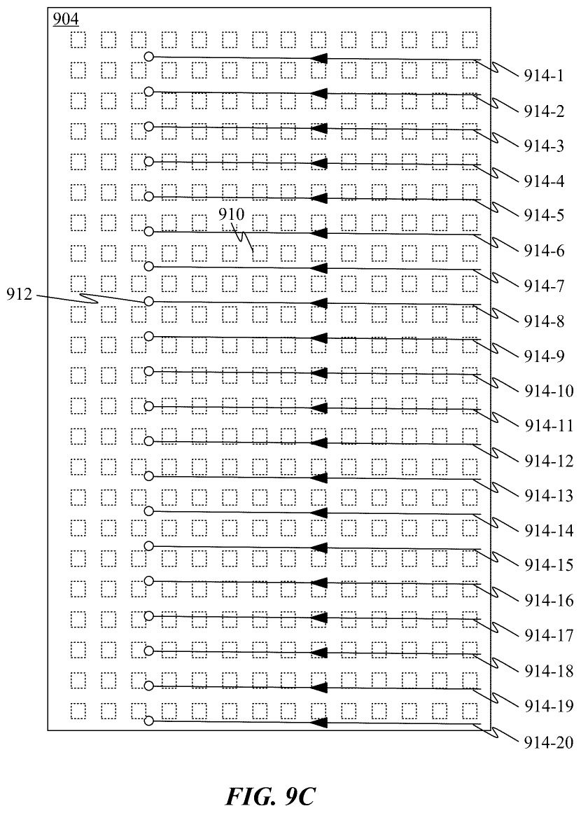

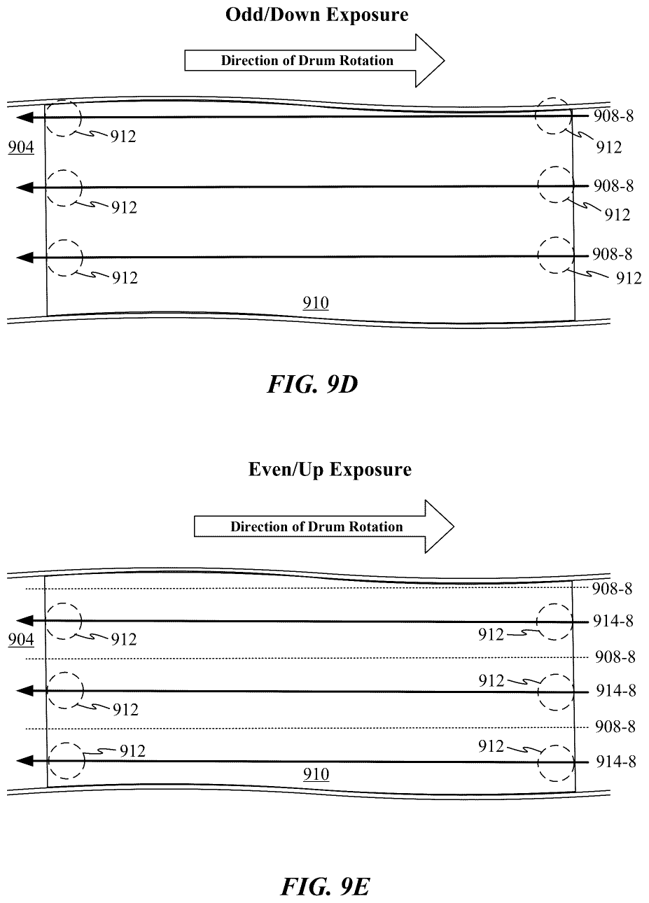

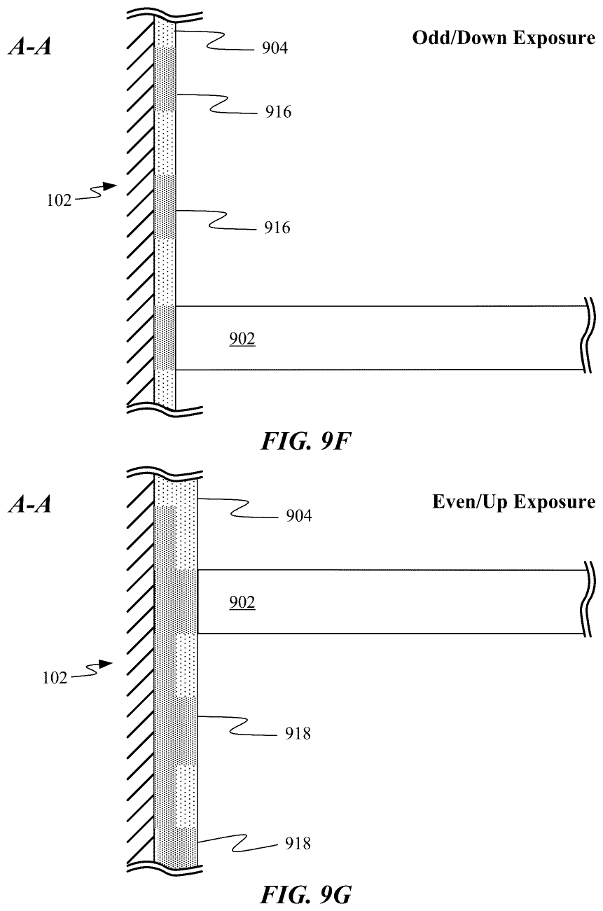

FIGS. 9A-9G illustrate a method of operation of light source assembly 116 while creating parts within additive manufacturing system 100. FIG. 9A shows a top down cross-sectional view of drum 102 with light source assembly 116 disposed therein and in active operation. Laser diode 308 is shown emitting a laser beam 902 through lens assembly 302 at working material 904 disposed on an interior-facing curved surface of drum 102. Lens assembly 302 is configured to focus laser beam 902 on a surface of working material 904. Lens assembly 302 will generally be configured to focus laser 902 to make an area of working material 904 occupied by the laser as small as laser diodes 308 and lens assembly 302 within light source assembly 116 allow. In an exemplary embodiment, a circular diameter of 30 microns can be achieved. By minimizing the size of the laser beam in this way, a resolution and/or accuracy of a resulting part can be maximized. Dashed sector lines 906 indicate a portion of working material 904 that is depicted in FIGS. 9B and 9C below.

FIG. 9B shows a portion of working material 904 in accordance with sector lines 906 as light source 116 (see FIG. 9A) begins travelling downwards. In particular, FIG. 9B shows how laser diodes of light source assembly 116 are configured to trace downward-sloped scanlines 908 across working material 904 that follows a helical pattern across working material 904 as the drum rotates in the indicated direction and light source assembly 116 travels downward. The dashed squares shown in FIG. 9A represent an array of parts that can be created by the additive manufacturing system and includes part 910. The circles located at the end of each of downward-sloped scanlines 908 represent laser footprints 912 where a respective laser diode would shine its laser if the respective laser diode were being actuated. It should be noted that a size of laser footprint 912 is exaggerated in this figure to help clearly show the positions of laser footprints 912 relative to one another being aligned vertically as they are aligned vertically within light source assembly 116.

In one exemplary embodiment, a distance between the laser diodes and downward-sloped scan lines 908 is 1 cm. This distance is referred to as a scanline interval since the laser diode spacing also corresponds to a distance between adjacent scanlines. During operation, light source assembly 116 will move slowly downward toward a base of drum 102. This gradual movement is why each of downward-sloped scan lines 908 is shown having a gradual declination. In the exemplary embodiment where laser diodes are separated by 1 cm, light source assembly 116 can be configured to travel at a speed where, e.g., downward-sloped scan line 908-7 doesn't reach the position shown in FIG. 8B of downward-sloped scan line 908-8 until the drum has been rotated 100 times, resulting in a distance of a 100 micron spacing between scan lines as the drum rotates. While this allows the laser diodes many passes across working material 904, when the diameter of the laser diodes is focused to a particularly small size such as 20-40 microns in diameter portions of material 904 located between scan lines 908 can remain unsolidified.

FIG. 9C shows the same portion of the layer of working material 904 shown in FIG. 9B, in accordance with sector lines 906, as light source 116 (see FIG. 9A) begins travelling back upwards following a subsequent layer of working material being added to working material 904. In particular, FIG. 9C shows how laser diodes of the light source assembly are configured to trace upward-sloped scanlines 914 across working material 904. As with FIG. 9B, the size of laser footprint 912 is exaggerated in this figure to help clearly show the position of laser footprint 912 relative to other laser footprints associated with other laser diodes. The combination of FIGS. 9B and 9C show movement of upward-sloped scan lines 908 near their uppermost starting positions in FIG. 9B to a location near their lowermost positions in FIG. 9C. In particular, downward-sloped scan line 908-8 is located above part 910 in FIG. 9B and upward-sloped scan line 914-8 (associated with the same laser diode as scan line 908-8) is located below part 910 in FIG. 9C. Upward-sloped scan lines 914 are also shown having a very slight upward trajectory such that as light source assembly 116 moves upward each of scan lines 908 traces a helical pattern in order to cover the intervening 1 cm distance between adjacent laser diodes. Upward-sloped scanlines 914 can be vertically offset from downward-sloped scanlines 908 such that scan lines 914 pass between scanlines 908. Even though the upward-sloped scanlines 914 trace across a layer of working material 904 immediately above the layer traced across by scanlines 908, the laser depth can be set such that the laser solidifies working material 904 positioned in multiple layers as is shown in greater detail in FIG. 9G.

FIGS. 9D-9E show a close up view of a portion of part 910 and how adjacent passes of scanlines 908-8 and 914-8 work cooperatively to solidify a current layer of working material 904 needed to form part 910. In particular, FIG. 9D shows how a footprint 912 of a laser emitted by the laser diode associated with scanlines 908-7 and 914-7 traverses from the right to the left side of part 910 tracking slowly downward while tracing scanlines 908. The dashed lines indicating footprint 912 in FIG. 9D show how a portion of material 904 disposed between adjacent scanlines 908-7 leaves a gap that goes unsolidified.

FIG. 9E shows scanlines 914 overlaid next to scanlines 908 and illustrates how a vertical offset between scanlines 908 and scanlines 914 of half of a scanline interval allows scanlines 914 to cover the portion of working material 904 that is left unsolidified due to the gap between adjacent scanlines 908. Scanlines 908 are left dashed in FIG. 9E to illustrate that these scans have already taken place. FIG. 9E also indicates how a distance between scanlines 908 and 914 changes during rotation of the drum. In some embodiments, operation of the laser diodes can be adjusted when scanlines 908 and 914 begin to converge and diverge from each other. For example, a power output of the laser diode can be reduced or turned off in areas of working material where the additive manufacturing system predicts some amount of overlap of scanlines 908 and 914. Furthermore, when light source module 116 approaches the bottom of its downward travel a power output of the laser diodes can be reduced to prevent an instance where overlap between, e.g., scanlines 908-7 and 908-8 results in more than a threshold amount of light energy being imparted to a portion of the working material, resulting undesirable part defects.

Alternatively or additionally, a layout of parts can be adjusted to avoid areas of the interior-facing surface of the drum that are determined to have higher amounts of convergence of scanlines 908 and 914. In the event part locations are adjusted in this manner a vertical offset between scanlines 908 and 914 can be established with precision by referencing position data from the laser indexer sensor described above to maximize performance in areas where parts are being built within drum 102 and a starting location of scanlines 914 can be established with a half scan line interval spacing from a predetermined starting point so that maximum performance areas remain synchronized with part locations.

FIGS. 9F and 9G show a cross-sectional side view of a wall of drum 102 in accordance with section line A-A from FIG. 9A during up and downward passes of laser 902. In particular, FIG. 9F shows a first layer of material 904 deposited on the wall of drum 102 and how successive passes of laser 902 form solidified portions 916 of material 904 that would be used to form one a part. FIG. 9G shows how after adding a second layer of working material onto the first layer of working material 904 application of energy to working material 904 creates additional solidified portions 918 that extend through both layers so that the solidified material portions 916 are linked together by solidified material portions 918. This is accomplished by setting an effective solidification depth of laser 902 into the working material to penetrate two layers. Previously described FIG. 6 describes how solidification depth can be established as a function of laser power.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the disclosure is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

What is claimed is:

1. An additive manufacturing system, comprising:
a drum having an interior-facing curved surface;
a light source module comprising a plurality of light sources; and
a processor configured to execute computer code that when executed causes the additive manufacturing system to:
rotate the drum;
apply a first layer of working material to the interior-facing curved surface;
move the light source module disposed at least partially within the drum toward a base of the drum such that the plurality of light sources follow a first plurality of scanlines across the first layer of the working material in a first helical pattern;
apply a second layer of working material to the interior-facing curved surface atop the first layer of working material; and
move the light source module away from the base of the drum such that the plurality of light sources of the light source module follow a second plurality of parallel scanlines across the second layer of material in a second helical pattern,
wherein the light source module moves at a speed such that actuation of a light source of the plurality of light sources over a first region of the working material during two consecutive rotations of the drum results in unsolidified material being left between a first portion of the first region solidified by the light source during a first one of the consecutive rotations and second portion of the first region solidified by the light source during a second one of the consecutive rotations.

2. The additive manufacturing system of claim 1, wherein the first plurality of scanlines are vertically offset from the second plurality of scanlines.

3. The additive manufacturing system of claim 2, wherein the plurality of light sources are each separated by a scanline interval and the first plurality of scanlines is offset vertically from the second plurality of scanlines by half of a scanline interval.

4. The additive manufacturing system of claim 1, wherein the plurality of light sources are turned on and off during rotation of the drum and vertical movement of the light source module to solidify portions of the first and second layers of working material to form one or more parts on the interior-facing curved surface of the drum.

5. The additive manufacturing system of claim 1, further comprising a motor configured to move the light source module toward and away from the base of the drum.

6. The additive manufacturing system of claim 1, further comprising:
a sensor configured to measure a rotational position of the drum, wherein the additive manufacturing system direct changes to operation of the light source module based on a determined rotational position and/or speed of the drum.

7. The additive manufacturing system of claim 6, wherein the sensor is a laser indexer and wherein the processor is configured to interpolate a rotational position of the drum based on a tic mark of the laser indexer most recently detected by the laser indexer and an estimated rotational speed of the drum.

8. The additive manufacturing system of claim 1, wherein the plurality of light sources are laser diodes arranged vertically within the light source module.

9. The additive manufacturing system of claim 1, wherein the additive manufacturing system reduces a power output of a first light source of the plurality of light sources when the first light source is tracking across a final rotation of the drum before the light source assembly changes direction within the drum, such that portions of the working material where a first scanline of the first light source overlaps a second scanline of the second light source do not receive too much light energy.

10. The additive manufacturing system of claim 1, wherein the light source module pauses operation while the second layer of working material is applied to the interior-facing curved surface of the drum.

11. A method, comprising:
rotating a drum of an additive manufacturing system;
applying a first layer of working material to an interior-facing curved surface of the drum;
moving a light source module disposed at least partially within the drum toward a base of the drum such that a plurality of light sources of the light source module trace a first plurality of scanlines across the working material on the interior-facing curved surface of the drum in a first helical pattern;
applying a second layer of working material to the interior-facing curved surface of the drum; and
moving the light source module away from the base of the drum such that the plurality of light sources of the light source module trace a second plurality of parallel scanlines across the second layer of working material on the interior-facing curved surface of the drum in a second helical pattern,
wherein the light source module moves at a speed such that actuation of a light source of the plurality of light sources over a first region of the working material during two consecutive rotations of the drum results in unsolidified material being left between a first portion of the first region solidified by light source during a first one of the consecutive rotations and second portion of the first region solidified by the light source during a second one of the consecutive rotations.

12. The method of claim 11, wherein the first plurality of scanlines are vertically offset from the second plurality of scanlines.

13. The method of claim 11, wherein scanlines of the first plurality of scanlines are vertically offset from each other by a scanline interval and the second plurality of scanlines are vertically offset from the first plurality of scanlines by half of a scanline interval.

14. The method of claim 11, further comprising:
turning on and off the plurality of light sources during rotation of the drum and vertical movement of the light source module to solidify portions of the first and second layers of working material to form one or more parts on the interior-facing curved surface of the drum.

15. The method of claim 11, wherein the additive manufacturing system comprises a motor configured to move the light source module toward and away from the base of the drum.

16. The method of claim 11, wherein the additive manufacturing system includes a sensor configured to measure a rotational position of the drum and the method further comprises:
directing changes to operation of the light source module based on a determined rotational position and/or speed of the drum.

17. The method of claim 16, wherein the sensor is a laser indexer and wherein the method further comprises interpolating a rotational position of the drum based on a tic mark of the laser indexer most recently detected by the laser indexer and an estimated rotational speed of the drum.

18. The method of claim 11, wherein the plurality of light sources are laser diodes arranged vertically within the light source module.

19. The method of claim 11, further comprising reducing a power output of a first light source of the plurality of light sources when the first light source is traversing a final rotation of the drum before the light source assembly changes direction within the drum, such that portions of the working material where a first scanline of the first light source overlaps a second scanline of the second light source do not receive more than a threshold amount of light energy.

20. The additive manufacturing system of claim 1, further comprising pausing operation of the light source module while the second layer of working material is applied to the interior-facing curved surface of the drum.
